(19) United States
(12) Patent Application Publication
(10) Pub. No.: US 2003/0181162 A1
(43) Pub. Date: Sep. 25, 2003

(54) " Satellite set-top box for mobile applications "

(76) Inventor: Michael Matula, Laguna Beach, CA (US)

Correspondence Address: WILLIE KRAWITZ, 3001 CHAPEL HILL ROAD, ORANGE, CA, 92867, US

(21) Appl. No.: 10/102,438

(22) Filed: Mar. 20, 2002

(51) Int. Cl. H04B 7/185

(52) U.S. Cl. 455/13.3; 455/12.1

(57) ABSTRACT

A mobile satellite set-top box provides a satellite modem for internet (URL) service, a DBS receiver for TV service, and a GPS receiver for navigational use. The satellite set-top box may be used in mobile or stationary applications such as recreational vehicles, trucks and sea vessels. The set-top box connects to a satellite dish and a GPS antenna for receiving satellite signals. These signals are directed to a motherboard (CPU) in the set-top box which processes user selected outputs such as TV, GPS display or a wireless connection to a personal computer.

### BACKGROUND OF THE INVENTION

This invention relates to a new and improved system and method for providing in an inexpensive manner a location means for a moving carrier such as a vehicle and sea vessel in addition to the various functions usually associated with satellite reception such as TV, internet service, etc. for individual use, or for an integrated display.

These functions are frequently provided by separate display connections which tend to be expensive and awkward to control since functions such as TV, internet service and the navigation and location status position of the moving carrier are frequently difficult to monitor and operate.

### THE INVENTION

According to the invention, an integrated control and method is provided to separately receive and direct signals from a satellite transmitter to the various output functions while being controlled and/or monitored by a single operator. The control function greatly improves the efficiency of the overall reception capability and enables a more efficient handling of satellite receptions by combining the individual reception functions into a single set-top box which in turn are connected to the individual displays.

### IN THE DRAWINGS

FIG. 1 is an overview of satellite transmitters, GPS antenna and satellite dish mounted on a vehicle;

FIG. 2 is an overview of the satellite transmitters, GPS antenna, satellite dish and mobile satellite set-top box of this invention;

FIG. 3 is a system flow block diagram of the satellite set-top box of this invention; and,

FIG. 4 is a diagrammatic representation of various connections from the set-top box to the respective outputs.

### DESCRIPTION OF THE PREFERRED EMBODIMENTS:

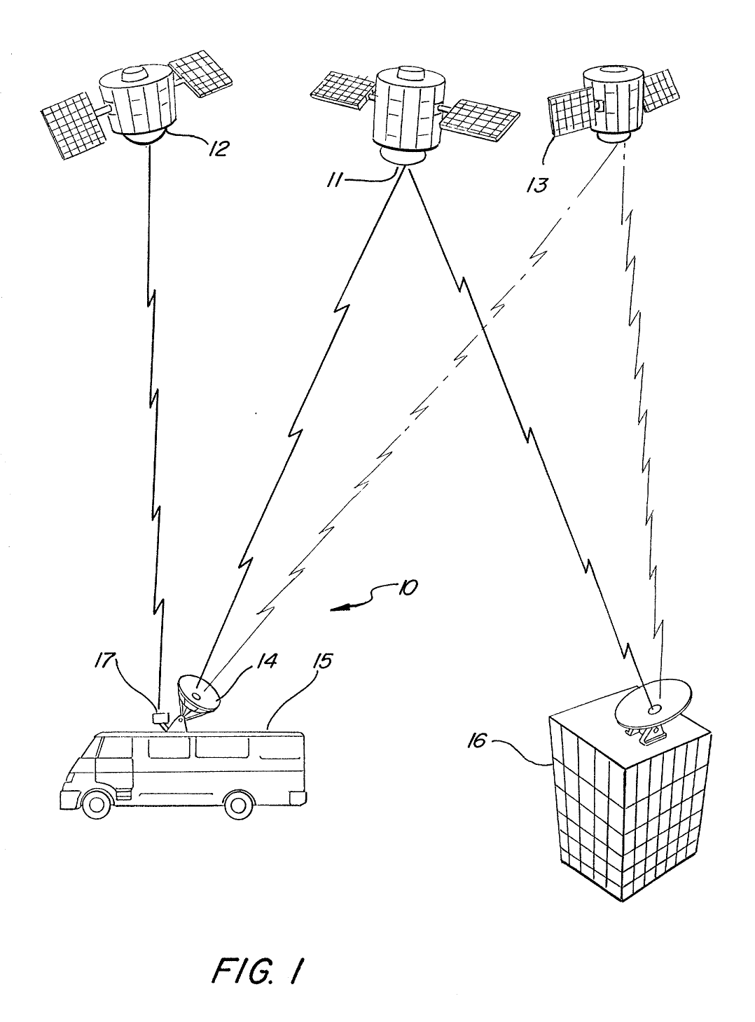

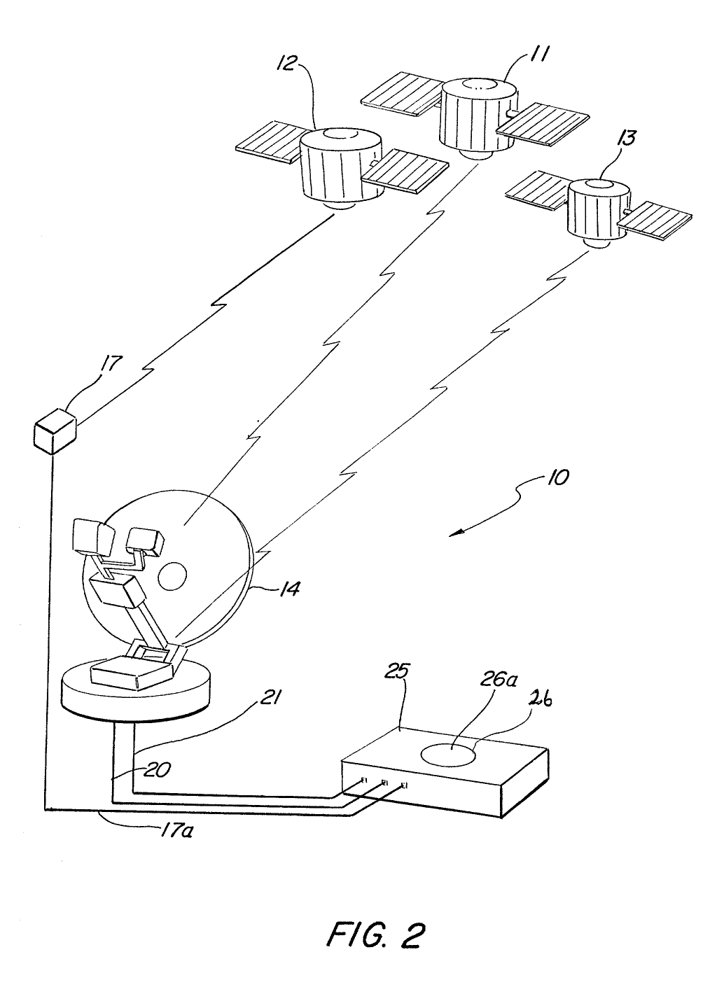

The overall receiving system 10 and method of this invention is shown in FIGS. 1 and 2, and shows individual satellites 11, 12 and 13 which directs respective DBS (TV), GPS and internet signals to a rotatable satellite dish 14 mounted on a vehicle 15. The internet and DBS signals may originate from a separate ground facility 16, and the satellite dish 14 is designed for the usual reception of DBS (TV) and internet signals. A GPS antenna 17 mounted on the satellite dish 14 receives signals from the satellite 12 and is connected along with signals from the TV and internet to a satellite set-top box as will be described, infra.

FIG. 2 shows the satellite dish 14 and includes the GPS receiver 17, DBS (TV) receiver, and an internet receiver, with corresponding connection lines 17a, 20 and 21 being made from their respective receivers to the satellite set-top box 25. A slot insertion placement 26 is provided on the set-top box 25 for insertion therein of a GPS mapping software disc 26a.

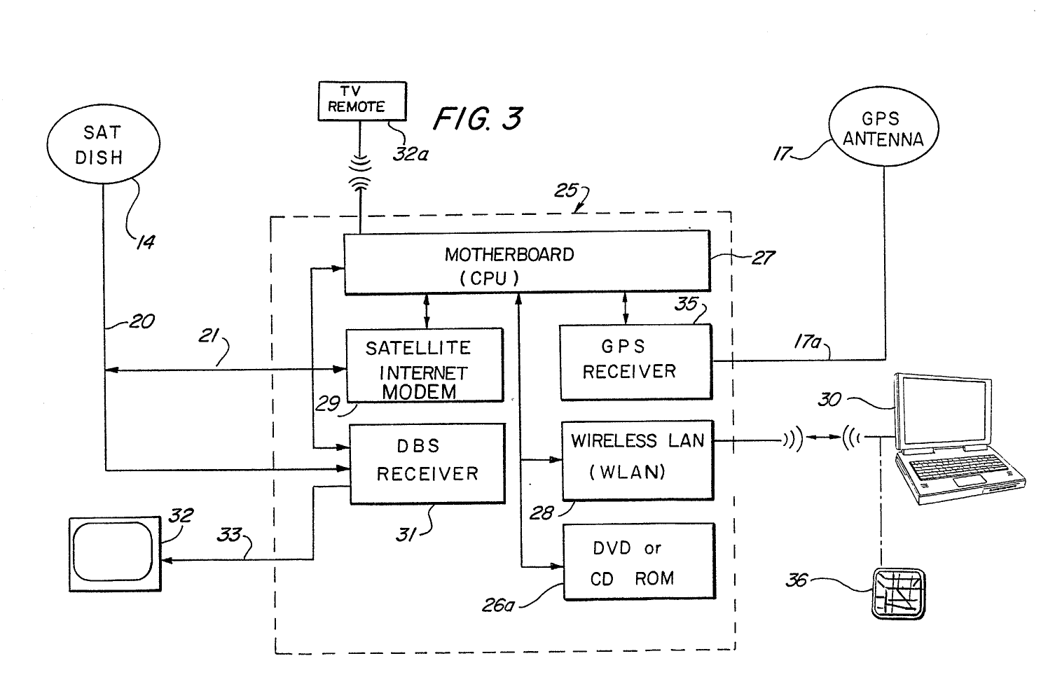

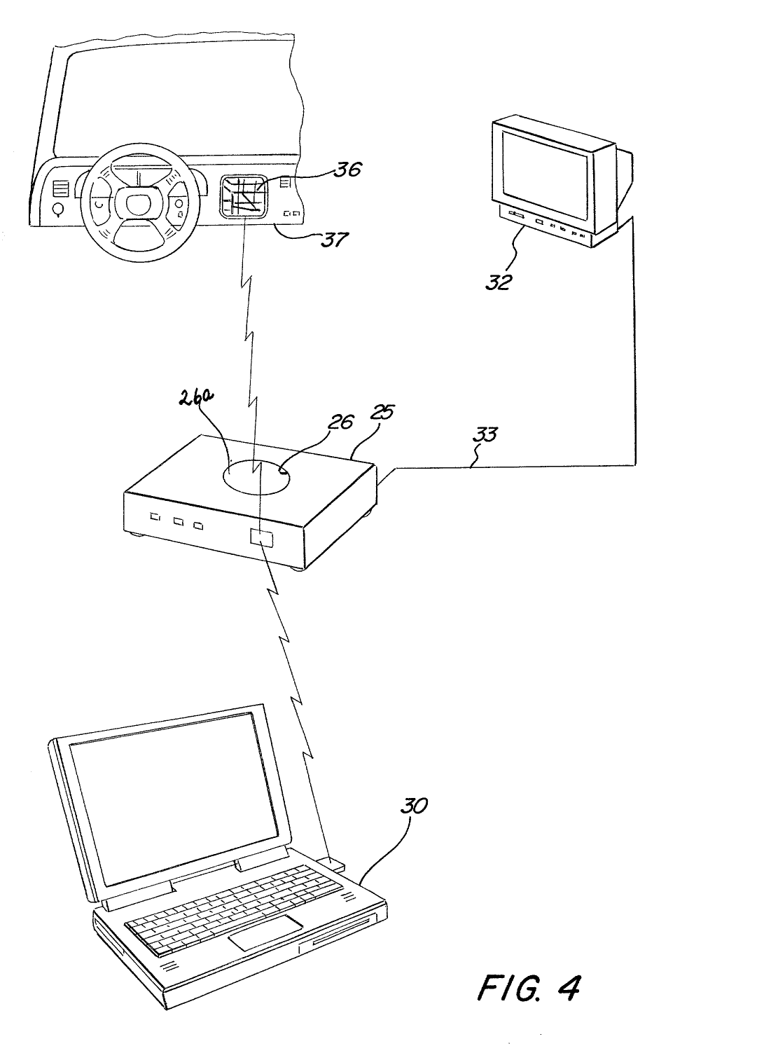

A block diagram of the satellite internet function shown in FIG. 3 includes a motherboard CPU 27 mounted within the set-top box 25 of this invention which is adapted to receive a request for data from a user via the wireless LAN (WLAN) port 28. This request, in the form of a URL (www.address.com), is transmitted to the internet satellite 13 via the satellite internet modem 29 and connected line 21 to the satellite dish 14. A response to the requested data is returned through the satellite dish and internet satellite modem 29 to the motherboard CPU 27 which then distributes the data to the user's personal computer 30 (FIG. 4) via wireless LAN (WLAN) port 28.

In the case of DBS TV signals shown in FIG. 3, a request from the motherboard CPU 27 is sent from a user to the set-top box DBS receiver 31 to process a DBS signal from connected line 20 to the satellite dish 14 and to the user's connected TV outlet 32 (FIG. 4). Push button functions (not shown) on the DBS and/or the motherboard CPU 27 (or TV remote 32a) may be used to remotely control the TV outlet, besides the usual TV control functions.

As for the GPS navigation function shown in FIG. 3, a request for GPS coordinates (i.e., a location mapping file) is sent from the motherboard CPU 27 to the GPS receiver 35 which is connected 17a to the GPS antenna 17. Incoming GPS coordinates in response to the request are processed back through to the motherboard CPU from the GPS receiver 35. The motherboard CPU extracts a requested mapping file from the DVD or CD ROM disc 26a in the slot insertion 26 and sends back the navigational mapping file and/or voice information through the wireless LAN (WLAN) port 28 for an appropriate display 36 and/or voice information on the computer 30 or dashboard panel 37, as shown in FIG. 4. It will be appreciated that all necessary components are IEEE 802.11 or BLUETOOTH compliant.

The mobile satellite set-top box 25 of this invention is suited for use with mobile vehicles, boats, etc., where space is limited, and wired connections can be awkward. Also, actuation and monitoring of GPS signals can be conveniently effected through more than one outlet. This enables a passenger to direct a vehicle course so the driver can concentrate on steering rather than also having to monitor vehicle direction. When combined with the usual home office amenities, the satellite set-top box 25 enables a user to perform office functions while maintaining mobility.

1. A satellite set-top box and system for receiving GPS, TV and internet signals mounted on a moving carrier, comprising:
A.) a satellite dish for receiving satellite signals mounted on the carrier;
B.) GPS, TV and internet receiving means mounted on the satellite dish; and,
C.) a satellite set-top box connected to the satellite dish, the satellite set-top box including i. a GPS receiver providing a mapping function means; an internet modem; and, a DES receiver for TV signals; the GPS receiver, internet modem and DES receiver being connected to the satellite set-top box; ii. the GPS receiver being adapted to send mapping coordinate requests to the satellite dish and receive mapping information in the form of a display or voice message therefrom; iii. a WLAN port connected from the internet modem to the satellite dish for sending a URL (www.address.com) request and for receiving a response signal from the satellite dish; and,
iv. a CPU for: a.) receiving request signals from the GPS, DES and internet receivers; b.) directing URL and GPS requests to the satellite dish; c.) receiving URL and GPS response signals from the satellite dish and directed to respective URL and GPS displays; and,
d.) receiving DES signals from the satellite dish and directing these signals to a TV display.

2. The system of claim 1, in which the satellite dish is rotatable.

3. The system of claim 1, including computer display means for the URL and GPS signals, a separate additional display panel being provided for the GPS signal.

5. The system of claim 1, including a mapping disc for transmitting GPS requests and responses to the CPU.

6. A method for transmitting and receiving request and response signals for URL, GPS and DBS signal means which are mounted on a mobile carrier, the signal means including a satellite dish for receiving DBS signals, and for receiving and transmitting internet and GPS request and response signals, the URL, GPS request and response signal means and the DBS receiving means being mounted in a set-top box on the mobile carrier and connected to the satellite dish; and, a CPU mounted in the set-top box, the CPU being connected to the URL, GPS request and response means, and to the DBS receiving means; whereby, the CPU receives request signals from the URL and GPS receivers; transmits URL and GPS requests to the satellite dish; and, directs DBS signals, URL and GPS response signals from the satellite dish to respective outlets on the carrier.

7. The method of claim 6, in which GPS information is stored on a disc mounted on the set-top box and request and responses are displayed on a computer, or a display panel.

8. The method of claim 6, in which a WLAN port connects a URL modem with the satellite dish, and the WLAN port sends and receives responses for a URL request to the satellite dish.

9. The method of claim 6, in which output from the URL modem is displayed on a computer.

10. The method of claim 6, in which the satellite dish is rotatable.

11. A satellite set-top box incorporating GPS, TV and internet modules for receiving signals from a satellite, the set-top box being mounted on a moving carrier; GPS, TV and internet receiving means mounted on the satellite and connected to their respective modules; the GPS receiver providing a mapping function means; an internet modem; and, a DBS receiver modem for receiving TV signals; the GPS receiver being adapted to send mapping coordinate requests to the satellite dish and receive mapping information in the form of a display or voice message therefrom; a WLAN port connected from the internet modem to the satellite dish for sending a URL (www.address.com) request and for receiving a response signal from the satellite dish; and, a CPU for: receiving request signals from the GPS, DBS and internet receivers; cirecting URL and GPS requests to the satellite dish; receiving URL and GPS response signals from the satellite dish and directed to respective URL and GPS displays; and, receiving DBS signals from the satellite dish and directing these signals to a TV display.
